(19) United States
(12) Patent Application Publication
(10) Pub. No.: US 2008/0016571 A1
(43) Pub. Date: Jan. 17, 2008

(54) Rootkit detection system and method

(76) Inventor: Larry Chung Yao Chang, Walnut, CA (US)

Correspondence Address: CHRISTIE, PARKER & HALE, LLP, PO BOX 7068, PASADENA, CA, 91109-7068, US

(21) Appl. No.: 11/485,036

(22) Filed: Jul. 11, 2006

(51) Int. Cl. G06F 12/14; H04L 9/32; G06F 11/00; G06F 11/30; G06F 12/16; G06F 15/18; G08B 23/00

(52) U.S. Cl. 726/24; 713/188

(57) ABSTRACT

A system and method is provided for detecting operating system compromises due to inconspicuous rootkit installations. A rootkit detection module identifies hidden processes running on top of the operating system. Processes operating in an uncompromised environment expose their process identifiers (PIDs) to the operating system. Thus, if a hidden process is discovered, this is an indication that a rootkit program may have compromised the operating system. The rootkit detection mechanism according embodiments of the present invention detect hidden processes by identifying a range of all possible PIDs and identifying PIDs that are not being reported by the operating system. Specifically, the rootkit detection mechanism according to one embodiment of the invention tests each PID in the range via lower level function calls that do not rely on published operating system APIs, and examines the memory location referenced by the PID for determining if a hidden process exists.

### FIELD OF THE INVENTION

This invention relates generally to detecting compromises to an operating system, and more specifically, to detecting inconspicuous rootkit installations.

### BACKGROUND OF THE INVENTION

A rootkit is a collection of programs that allows a hacker to gain administrative-level access to a computer or computer network. Once the rootkit is installed, it allows the attacker to mask intrusion and gain root or privileged access to the computer and, possibly, other machines on the network. For example, the rootkit may be used to monitor traffic and keystrokes, create a backdoor into the system for the hacker's use, alter log files, attack other machines on the network, and alter existing system tools to circumvent detection.

In order for a rootkit to alter the normal execution path of an operating system, one of the techniques it may employ is to manipulate operating system kernel objects. This type of rootkit relies on the fact that the operating system creates kernel objects in order to do bookkeeping and auditing. If a rootkit modifies these kernel objects, is subverts what the operating system believes exists on the system.

For example, certain rootkits modify the kernel object that represents the processes on the system. All the kernel process objects are linked. When a user queries the operating system for the list of processes through an application program interface (API), the operating system walks a linked list of process objects and returns the appropriate information. However, certain rootkits unlink the process objects of the processes that the rootkits desire to hide. The unlinked processes, therefore, are not discovered by the operating system.

Accordingly, what is desired is a system and method for detecting inconspicuous rootkit installations.

### SUMMARY OF THE INVENTION

According to one embodiment, the present invention is directed to a method, system, and computer readable medium for detecting a rootkit application installed in a computer device. The computer device includes an operating system on which one or more processes are run. Each of the one or more processes has a process object identified by a process identifier. A rootkit detection module installed in the computer device is configured to identify a range of process identifier values; test each process identifier value in the range for determining whether the process identifier is associated with a valid process object; generate a first list including each process identifier determined, based on the testing, to be associated with a valid process object; query the operating system for a list of valid processes; receive, in response to the query, one or more process identifiers for the one or more of the valid processes identified by the operating system; generate a second list including the one or more process identifiers for the one or more of the valid processes identified by the operating system; compare the process identifiers in the first list with the process identifiers in the second list; identify a process identifier missing from the second list; and output information on the process identifier missing from the second list. The process identifier that is unreported by the operating system indicates that a rootkit application has compromised the operating system.

According to one embodiment of the invention, the testing of each process identifier is via a function call that does not rely on a published application program interface provided by the operating system.

According to one embodiment of the invention, the rootkit detection is invoked in a computer investigation system including a target machine and an examining machine coupled to the target machine over a data communications network. The examining machine according to this embodiment is programmed to transmit a command for detecting a rootkit application installed in the target machine.

These and other features, aspects and advantages of the present invention will be more fully understood when considered with respect to the following detailed description, appended claims, and accompanying drawings. Of course, the actual scope of the invention is defined by the appended claims.

### BRIEF DESCRIPTION OF THE DRAWINGS

FIG. 1 is a block diagram of an exemplary computer investigation system with rootkit detection according to one embodiment of the invention;

FIG. 2A is a block diagram of an operating system of a particular target machine before the target machine is compromised by a rootkit installation;

FIG. 2B illustrates the operating system of FIG. 2A after a rootkit has been installed into the target machine;

FIG. 3 is a flow diagram of a process implemented by a rootkit detection module for detecting hidden processes in a particular target machine, and hence, the presence of a rootkit application in the machine, according to one embodiment of the invention; and

FIG. 4 is a process flow diagram for using lower level function calls to query for valid processes and for generating a first process detection list according to one embodiment of the invention.

### DETAILED DESCRIPTION

In general terms, embodiments of the present invention are directed to detecting operating system compromises due to inconspicuous rootkit installations. According to one embodiment, a rootkit detection module is provided for identifying hidden processes running on top of a particular operating system, such as, for example, the Windows® operating system. Although the Windows® operating system is used as an example, a person of skill in the art should recognize that the present invention are not limited to Windows®, and may extend to other operating systems known in the art, such as, for example, Linux®, AIX®, Solaris®, and the like.

Processes operating in an uncompromised environment expose their process identifiers (PIDs) to the operating system. Thus, if a hidden process is discovered, this is an indication that a rootkit program may have compromised the operating system. The rootkit detection mechanism according embodiments of the present invention detect hidden processes by identifying a range of all possible PIDS and identifying PIDs that are not being reported by the operating system. Specifically, the rootkit detection mechanism according to one embodiment of the invention tests each PID in the range via lower level function calls that do not rely on published operating system APIs, and examines the memory location referenced by the PID for determining if a hidden process exists.

Rootkit detection according to embodiments of the present invention may be provided in a computer investigation system such as, for example, the computer investigation system described in U.S. Pat. No. 6,792,545, the content of which is incorporated herein by reference.

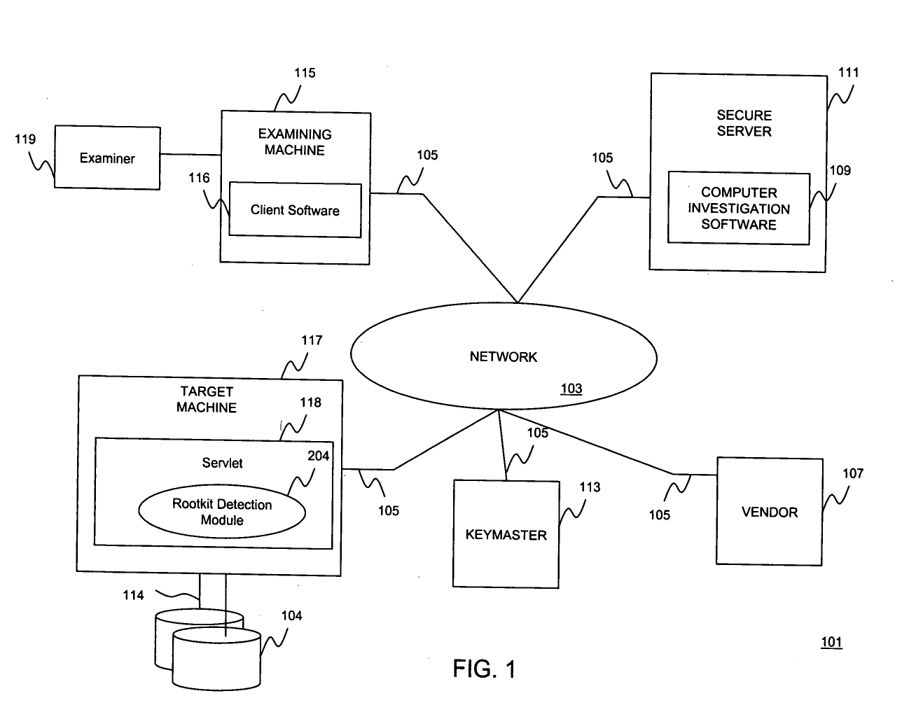

FIG. 1 is a block diagram of an exemplary computer investigation system 101 with rootkit detection according to one embodiment of the invention. The computer investigation system 101 includes various network devices coupled to a data communications network 103 over data communication links 105. The data communications network 103 may be a computer network, such as, for example, a public Internet, a private wide area network (WAN), a local area network (LAN), or other wired or wireless network environment conventional in the art. The network devices may include a vendor computer 107, a secure server 111, an examining machine 115, one or more target machines 117, and a keymaster computer 113. The data communication link 105 may be any network link conventional in the art, such as, for example, an Ethernet coupling.

A vendor having access to the vendor computer 107 provides the organization with a computer investigation software 109 which enables the organization to effectively perform forensic investigations, respond to network safety alerts, and conduct network audits over the data communications network 103. The computer investigation software 109 may also allow other investigations of networked devices in addition to forensic investigations as evident to those of skill in the art.

The investigation software 109 is installed in a local memory of the secure server 111 allocated to the organization. According to one embodiment of the invention, the computer investigation software 109 provides computer program instructions which, when executed by one or more processors resident in the secure server 111, cause the secure server to broker safe communication between the examining machine 115 and the target machines 117. The computer investigation software further facilitates the administration of users, logs transactions conducted via the server, and controls access rights to the system.

The examining machine 115 (which may also be referred to as the client) allows an authorized examiner to conduct searches of the target machines 117 and their associated secondary storage devices 104. In this regard, the examining machine 115 includes a client software 116 which includes the functionality and interoperability for remotely accessing the secure server 111 and corresponding target machines 117, and invoking different investigations and/or audits on the target machines. According to one embodiment of the invention, the client software 116 provides a graphical user interface for allowing the examiner to search one or more particular target machines or the entire network for hidden rootkits that may compromise the network.

Each target machine 117 is exemplarily the subject of a computer investigation conducted by the examining machine 115. The target machine typically includes a random access memory (RAM), a read only memory (ROM), and a central processing unit (CPU). The target machine may also include an input device, such as, for example, a keyboard and/or mouse, and an output device, such as, for example, a monitor. Each target machine 117 is further coupled to one or more secondary storage devices 104 over an input/output connection 114. The storage devices include any nonvolatile storage media such as, for example, hard disks, diskettes, Zip drives, redundant array of independent disks (RAID) systems, holographic storage devices, and the like.

According to one embodiment, a servlet 118 installed on a particular target machine 117 responds to commands provided by the examining machine 115 to remotely discover, preview, and acquire dynamic and/or static data, and transmit the acquired data to the examining machine via the secure communication path created between the target machine and the examining machine. The servlet may be implemented as any software module conventional in the art, and is not limited to just applets in a web browser environment.

According to one embodiment of the invention, the servlet 118 includes a rootkit detection module 204 which allows rootkit detection via identification of hidden processes. The rootkit detection module 204 may be implemented as a software module that may be linked to the operating system kernel of the target machine at runtime. The target machine may run on one of various operating platforms known in the art, such as, for example, Windows®, Linux®, AIX®, Solaris®, and the like.

An examiner in the computer investigation system 101 has direct or remote access to the examining machine 115 via an examiner device 119 in any manner conventional in the art. The examiner device 119 may be an input and/or output device coupled to the examining machine 115, such as, for example, a keyboard and/or monitor. The examiner device 119 may alternatively be a personal computer or laptop communicating with the examining device over a wired or wireless communication mechanism. According to one embodiment of the invention, the examiner is a trusted individual who safely stores in the examining machine 115, one or more encryption keys used for authenticating to the secure server 111 and conducting the secure investigation of the target machines 117, as is described in more detail in the above-referenced U.S. Pat. No. 6,792,545.

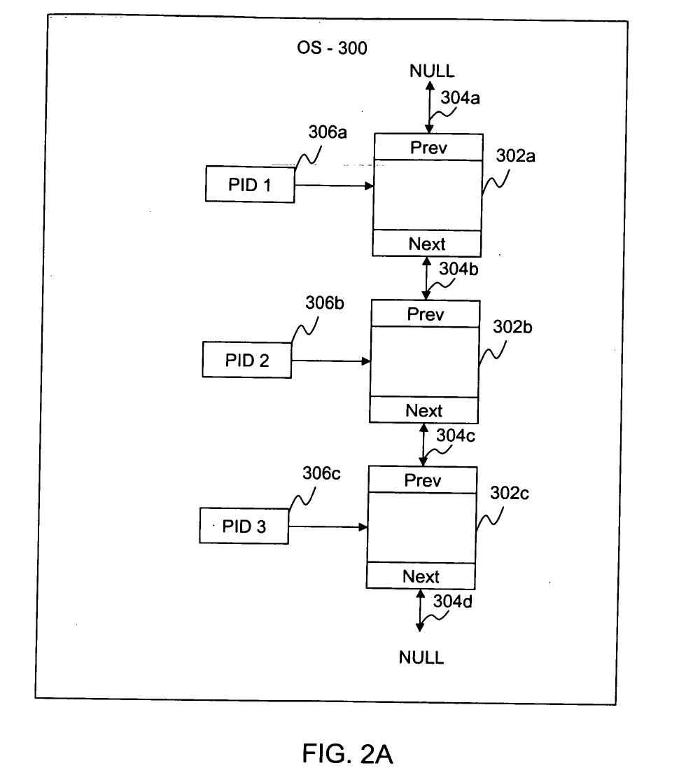

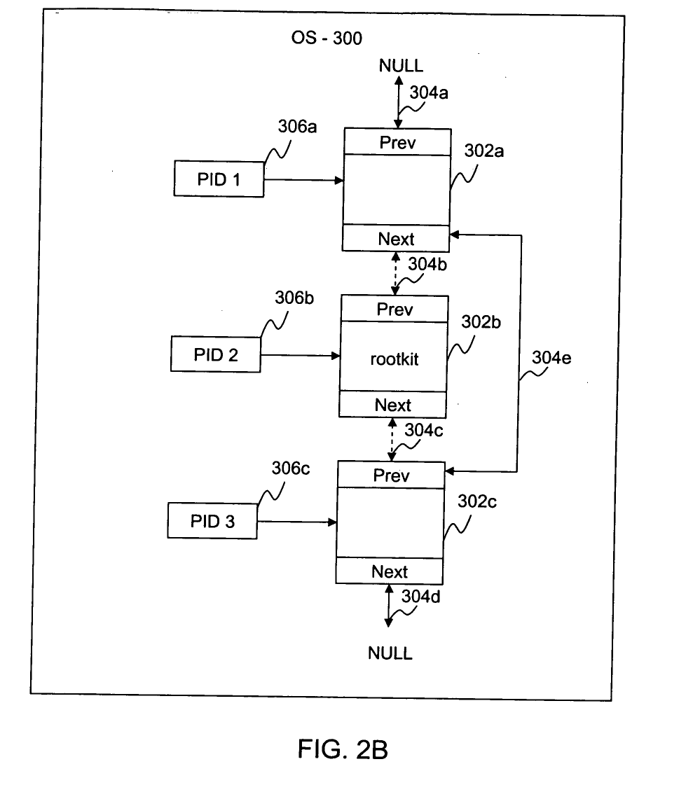

FIG. 2A is a block diagram of an operating system 300, such as, for example, the operating system of a particular target machine 117, before the target machine is compromised by a rootkit installation. In the illustrated embodiment, the operating system 300 generates various process objects 302a-302c for the processes running in the target machine. In the Windows® operating system, each process object is referred to as an executive process (“EPROCESS”) block. Each process object 302a-302c contains many attributes relating to the process as well as pointers to one or more related data structures.

In an uncompromised system, all the process objects 302a-302c are linked via pointers 302a-302d pointing to predecessor and successor objects. Each process object is identified by a PID 306a-306c which uniquely identifies the process object. When a user queries the operating system 300 for a list of all running processes through an API, the operating system walks the linked list of process objects and returns information for each running process.

FIG. 2B illustrates the operating system 300 of FIG. 2A after a rootkit installation causes the operating system to be compromised. The rootkit may be configured, for example, to hide one or more process objects running on top of the operating system. Such rootkits unlink the process object of the process it is hiding. In the example illustrated in FIG. 2B, the rootkit has hidden process object 302b by unlinking links 304b and 304c, and creating a new link 304d. In this example, when an application queries the operating system via the API to return a list of all running processes, only process objects 302a and 302c are returned. Process object 302b is not returned, and as far the querying application is concerned, the process does not exist. The unlinking of the process object 302b, however, does not alter the execution of the process object itself, or its location in virtual memory. Thus, the process object may be retrieved by directly accessing the memory location of the unlinked process object.

According to one embodiment of the invention, hidden processes, such as, for example, process associated with process object 302b, is detected by testing each possible PID, one by one, and determining if the PID references a process object that is not reported by the operating system. Thus, in the example of FIG. 2A, although the operating system only reports process objects 302a and 302c, the testing of each of the PIDs allows the detection of process object 302b in addition to process objects 302a and 302c, indicating that the operating system has been compromised by a rootkit application.

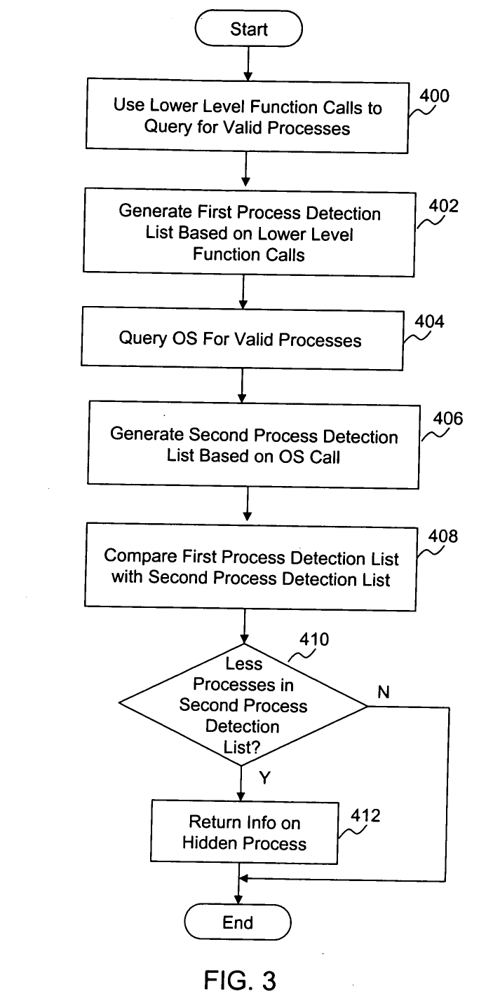

FIG. 3 is a flow diagram of a process implemented by the rootkit detection module 204 for detecting hidden processes in a particular target machine 117, and hence, the presence of a rootkit application in the machine, according to one embodiment of the invention. The rootkit detection process may be invoked, for example, by an authorized examiner via a graphical user interface provided by the client software 116.

The rootkit detection process may be described in terms of a software routine executed by the microprocessor in the target machine 117 based on instructions stored in the ROM. A person of skill in the art should recognize, however, that the routine may be executed via hardware, firmware (e.g. via an ASIC), or any combination of software, firmware, and/or hardware. Furthermore, the steps of the process may be executed in the indicated order, or in any other order recognized by a person of skill in the art.

In step 400, the rootkit detection module in the particular target machine 117 uses lower level function calls that do not rely on any published APIs provided by the operating system to obtain a list of valid processes. According to one embodiment of the invention, the lower level function calls are used to test each PID from a range of all possible PID values that could ever be used by a computer device. The rootkit detection module then generates, in step 402, a first process detection list with a list of all PIDs deemed to be valid based on the lower level function calls.

According to one embodiment of the invention, the PID value range that is tested via the lower level function calls is [0-65535]. A person of skill in the art should recognize, however, that as computer technology improves, the target machine will be able to handle a larger number of processes. Thus, according to one embodiment of the invention, the rootkit detection module 204 is updated as needed to increase the range of PIDs to examine.

In step 404, the rootkit detection module poses a query for valid processes to the operating system. According to one embodiment of the invention, the rootkit detection module uses an undocumented API provided by the operating system to query for the valid processes.

In step 406, the rootkit detection module generates a second process detection list with the PIDs of the processes returned by the operating system.

In step 408, the rootkit detection module compares the first process detection list against the second process detection list, and in step 410, determines if the second process detection list contains fewer PIDs than the first list due to a lesser number of processes being returned from the query to the operating system.

If the second process detection list contains fewer PIDs than the first process list, the rootkit detection module returns information for each hidden process in step 412. The information may include, for example, the PID of the hidden process. According to one embodiment of the invention, the rootkit detection module may also alert an authorized examiner about the hidden process. In response, the authorized examiner may invoke the examining machine 115 to take remediation action for eliminating or minimizing the threat posed by the rootkit application causing the hiding of the process.

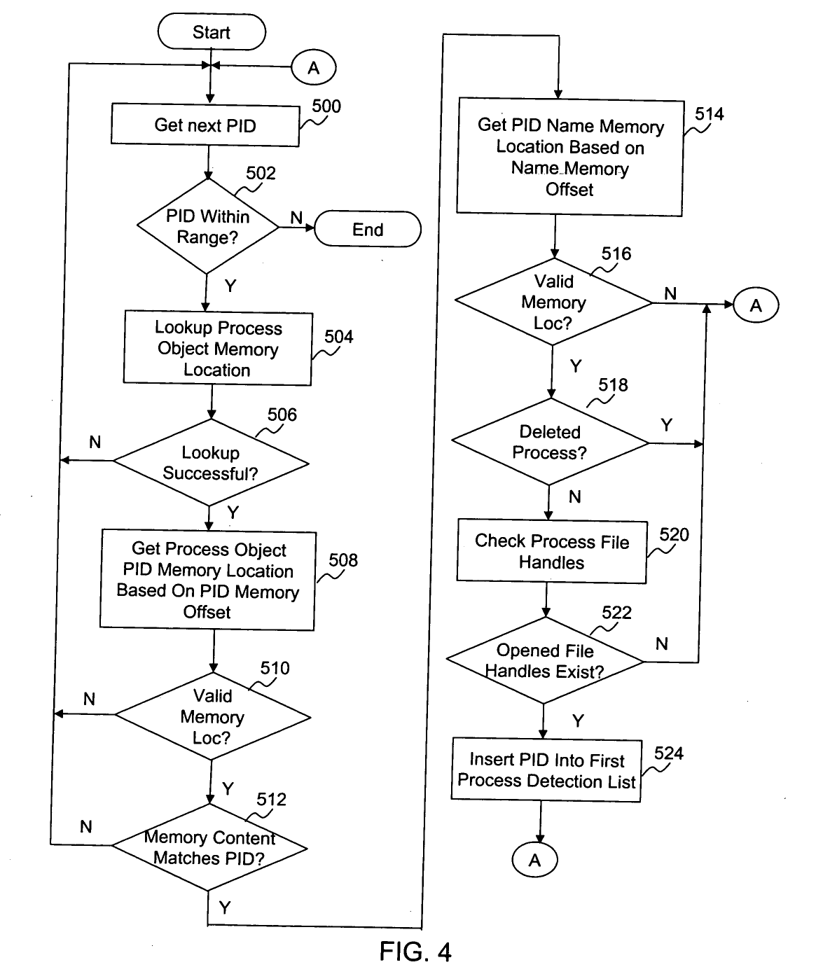

FIG. 4 is a more detailed process flow diagram of steps 400 and 402 for using the lower level function calls to query for valid processes and for generating the first process detection list according to one embodiment of the invention. In step 500, the rootkit detection module obtains a next PID that needs to be investigated. If no PIDs have been examined so far, the first PID that is investigated is 0. Otherwise, a current PID value is increased by one to get the next PID.

In step 502, a determination is made as to whether the PID being investigated is within a preset range of possible PID values. According to one embodiment of the invention, the range is from 0 to 65536.

If the PID is within range, a kernel function call is made in step 504 to obtain a process object memory location for the PID if one exists. For example, the Windows® operating system provides an undocumented kernel function call PsLookupProcessByProcessID which returns a memory location of where its EPROCESS would be stored. Such a function call does not make use of any published operating system APIs.

In step 506, a determination is made as to whether the lookup was successful. If the answer is YES, the memory location returned for the process object is nonetheless examined further to ensure that the process object is valid. In this regard, in step 508, the rootkit detection module obtains a memory location in the process object where its PID would be stored based on a precalculated PID memory offset. In step 510, a determination is made as to whether the memory location is valid. If the answer is YES, a determination is made, in step 512, as to whether the memory content matches the PID that is being investigated. If the answer is YES, the rootkit detection module, in step 514, proceeds to get a PID name memory location based on a precalculated PID name memory offset.

In step 516, a determination is made as to whether the PID name memory location is valid. If the answer is YES, a conclusion may be made that both the PID and the process name are valid. Nonetheless, further investigations are made to ensure that the PID may be inserted into the first process detection list. In this regard, in step 518, the process status is investigated to ensure that it is not a process that has been deleted from the OS (i.e. process status indicates that the process is running, idle, etc.). If a determination is made that the process has not been deleted from the OS, the rootkit detection module proceeds to check the process file handles in step 520. In step 522, a determination is made as to whether there are any opened file handles. If the answer is YES, the PID is valid. Thus, in step 524, the PID is inserted into the first process detection list.

Although this invention has been described in certain specific embodiments, those skilled in the art will have no difficulty devising variations to the described embodiment which in no way depart from the scope and spirit of the present invention. Furthermore, to those skilled in the various arts, the invention itself herein will suggest solutions to other tasks and adaptations for other applications.

For example, although rootkit detection is described as operating within a servlet in a computer investigation system, a person of skill in the art should recognize that rootkit detection module may be provided as a stand-alone tool for use on stand-alone computing devices. The rootkit detection tool may be provided on a computer-readable medium or downloaded over a data communications network for installing on the stand-alone computing devices. Also, rootkit detection may be implemented as part of the operating system code itself.

It is the applicants intention to cover by claims all such uses of the invention and those changes and modifications which could be made to the embodiments of the invention herein chosen for the purpose of disclosure without departing from the spirit and scope of the invention. Thus, the present embodiments of the invention should be considered in all respects as illustrative and not restrictive, the scope of the invention to be indicated by the appended claims and their equivalents rather than the foregoing description.

What is claimed is:

1. A method for detecting a rootkit application installed in a computer device, the computer device including an operating system on which one or more processes are run, each of the one or more processes having a process object identified by a process identifier, the method comprising:
identifying a range of process identifier values;
testing each process identifier value in the range for determining whether the process identifier is associated with a valid process object;
generating a first list including each process identifier determined, based on the testing, to be associated with a valid process object;
querying the operating system for a list of valid processes;
receiving, in response to the query, one or more process identifiers for the one or more of the valid processes identified by the operating system;
generating a second list including the one or more process identifiers for the one or more of the valid processes identified by the operating system;
comparing the process identifiers in the first list with the process identifiers in the second list;
identifying a process identifier missing from the second list; and
outputting information on the process identifier missing from the second list.

2. The method of claim 1, wherein the query to the operating system is via an undocumented application program interface.

3. The method of claim 1, wherein the testing of each process identifier is via a function call that does not rely on a published application program interface provided by the operating system.

4. The method of claim 1, wherein the rootkit application is one that compromises the operating system.

5. A computer device configured to detect installation of a rootkit application, the computer device including:
an operating system on which one or more processes are run, each of the one or more processes having a process object identified by a process identifier;
a processor; and
a memory operably coupled to the processor and having program instructions stored therein, the processor being operable to execute the program instructions, the program instructions including:
identifying a range of process identifier values;
testing each process identifier value in the range for determining whether the process identifier is associated with a valid process object;
generating a first list including each process identifier determined, based on the testing, to be associated with a valid process object;
querying the operating system for a list of valid processes;
receiving, in response to the query, one or more process identifiers for the one or more of the valid processes identified by the operating system;
generating a second list including the one or more process identifiers for the one or more of the valid processes identified by the operating system;
comparing the process identifiers in the first list with the process identifiers in the second list;
identifying a process identifier missing from the second list; and
outputting information on the process identifier missing from the second list.

6. The computer device of claim 5, wherein the query to the operating system is via an undocumented application program interface.

7. The computer device of claim 5, wherein the testing of each process identifier is via a function call that does not rely on a published application program interface provided by the operating system.

8. The computer device of claim 5, wherein the rootkit application is one that compromises the operating system.

9. A computer readable media embodying program instructions for execution by a computer device, the program instructions adapting the computer device for detecting a rootkit application installed in the computer device, the computer device including an operating system on which one or more processes are run, each of the one or more processes having a process object identified by a process identifier, the program instructions comprising:
identifying a range of process identifier values;
testing each process identifier value in the range for determining whether the process identifier is associated with a valid process object;
generating a first list including each process identifier determined, based on the testing, to be associated with a valid process object;
querying the operating system for a list of valid processes;
receiving, in response to the query, one or more process identifiers for the one or more of the valid processes identified by the operating system;
generating a second list including the one or more process identifiers for the one or more of the valid processes identified by the operating system;
comparing the process identifiers in the first list with the process identifiers in the second list;
identifying a process identifier missing from the second list; and
outputting information on the process identifier missing from the second list.

10. The computer readable media of claim 9, wherein the query to the operating system is via an undocumented application program interface.

11. The computer readable media of claim 9, wherein the program instructions for testing each process identifier is via a function call that does not rely on a published application program interface provided by the operating system.

12. The computer readable media of claim 9, wherein the rootkit application is one that compromises the operating system.

13. A computer investigation system comprising:
a target machine including an operating system on which one or more processes are run, each of the one or more processes having a process object identified by a process identifier; and
an examining machine coupled to the target machine over a data communications network, the examining machine programmed to transmit a command for detecting a rootkit application installed in the target machine,
wherein, responsive to the command, the target machine is programmed to:
identify a range of process identifier values;
test each process identifier value in the range for determining whether the process identifier is associated with a valid process object;
generate a first list including each process identifier determined, based on the testing, to be associated with a valid process object;
query the operating system for a list of valid processes;
receive, in response to the query, one or more process identifiers for the one or more of the valid processes identified by the operating system;
generate a second list including the one or more process identifiers for the one or more of the valid processes identified by the operating system;
compare the process identifiers in the first list with the process identifiers in the second list;
identify a process identifier missing from the second list; and
output information on the process identifier missing from the second list.

14. The system of claim 13, wherein the query to the operating system is via an undocumented application program interface.

15. The system of claim 13, wherein the testing of each process identifier is via a function call that does not rely on a published application program interface provided by the operating system.

16. The system of claim 13, wherein the rootkit application is one that compromises the operating system.
